(19) United States
(12) Patent Application Publication
(10) Pub. No.: US 2010/0113172 A1
(43) Pub. Date: May 6, 2010

(54) THREADING MACHINE FOR THE CONNECTION OF DEFORMED REINFORCING BARS

(75) Inventor: Jean-Jacques BRAUN, Bangkok (TH)

Correspondence Address: EGBERT LAW OFFICES, 412 MAIN STREET, 7TH FLOOR, HOUSTON, TX, 77002, US

(73) Assignee: DEXTRA ASIA CO., LTD., Bangkok (TH)

(21) Appl. No.: 12/609,214

(22) Filed: Oct. 30, 2009

(30) Foreign Application Priority Data
Nov. 3, 2008 (IN) 2344/MUM/2008

(51) Int. Cl. B23G 1/52; B23G 1/04

(52) U.S. Cl. 470/57; 408/42; 408/50; 408/104

(57) ABSTRACT

A threading machine for the end threading of long metal bars includes a peeler and a threader mounted co-axially on a spindle. The spindle is powered by a motor. A leading rod is attached to the clamping chariot. The leading rod includes the peeler opening and closing controller, and the threader opening and closing controller. The controllers are supported by a carriage set, and the threader is able to travel forward and backward. The peeler opening controller and threader opening controller are adjustable by moving them along leading rod to accommodate various thread length.

### CROSS-REFERENCE TO RELATED U.S. APPLICATIONS

Not applicable.

STATEMENT REGARDING FEDERALLY SPONSORED RESEARCH OR DEVELOPMENT

Not applicable.

### NAMES OF PARTIES TO A JOINT RESEARCH AGREEMENT Not applicable.

### REFERENCE TO AN APPENDIX SUBMITTED ON COMPACT DISC Not applicable.

### BACKGROUND OF THE INVENTION

1. Field of the Invention

This invention relates to the threading machine for the end threading of long metal bars or tubes, and in particular to the external threading of bars hat are not perfectly circular in shape.

2. Description of Related Art Including Information Disclosed Under 37 CFR 1.97 and 37 CFR 1.98.

The first method used to machine bars of irregular outer shape has been to first render them circular, either by grinding the ribs out (FIG. 1a), or by machining the ribs out or else by pressing the ribs to flatten them such as the system known under EP0947642 FIG. (1c). Once it has been rendered more or less circular, the bars can then be threaded by a regular threading machine. These processes are simple but present the great disadvantage of requiring at least two separate operations, sometimes three if the bar end must be cut before, or if both pressing and peeling are necessary. Multiplying the operations generates three drawbacks: first, it either increases the number of workers needed to operate the machines, or decreases the productivity as the worker must shift from one machine to the other; second, it increases the burden of material handling as these heavy steel bars must be transferred from one machine to the other, and third, when the bar is moved from one machine to the other, because of its irregular outer shape it cannot be clamped exactly in the same spot and orientation, which creates concentricity problems between the bar axis and the thread axis.

In order to solve these problems, machines have been developed that can do both the peeling and the threading operation. Thread cutting and thread rolling dies have been adapted to fit in CNC lathes and machining centers. These machines work very well on short pieces of bars, but not on long products. This is because, in this technology, the work pieces are clamped in a chuck and rotates while the tools and machining heads travel towards it in a straight motion (FIG. 2a-2b). With high rotational speeds now the norm for machining rotating long bars generates many problems such as safety concerns and machine damage. In the case of deformed or ribbed reinforcing bars, the unbalance due to their irregular shape generates momentum jerks that make machining all but impossible even at lower speeds.

In another particular design, the work piece is kept stationary, while the machining heads are rotary and mounted on a carriage that travels in two directions: moving the machining heads back and forth in front of the workpiece and back and forth towards it (FIG. 3). This technology gives excellent technical results but is of very limited use due to its prohibitive cost. Indeed each head must have its own electric motor to power it, and the travel of the chariot must be achieved with great accuracy so that at every cycle each ahead stops exactly in front of the work piece, with a precision compatible with that expected for the end product, which is in order of only some ten microns such machines are not only too expensive for the construction industry, they are also too sensitive and too complex to be put in the hands of construction workers and in the rough environment of a construction site or steel bending workshop.

### BRIEF SUMMARY OF THE INVENTION

The main object of the present invention is to provide a threading machine that is suitable for long work pieces of irregular outer shape, that can do both the surface preparation and the threading operation using only the two degrees of freedom that do not jeopardize the concentricity of the thread, the rotation of the heads around the same axis as the work piece, and the straight back and forth traveling along this same axis between the heads and the work piece. The machine should also be simple, thus cheap and easy to maintain and repair. An example of such bars with irregular outer shape is the so-called deformed or ribbed bars used for reinforcement of concrete. Such bars present ribs in both the radial and longitudinal directions that make them difficult to machine. These ribs are a hurdle to the machining of these bars, and dealing with them is complicated by the fact that they vary a lot in shape and dimensions from steel mill to another, from one bar lot to another, and even along bars from the same production lot.

Machining of reinforcing bars is necessary for a variety of purposes such as connecting them to one another, connecting them to steel structure, or fixing an anchor plate to their end.

### BRIEF DESCRIPTION OF THE SEVERAL VIEWS OF THE DRAWINGS

FIG. 1-3 are description of the prior art.

FIG. 1a through FIG. 1c are schematic views showing steps of three different methods presently used to transform the irregular outer shape of reinforcing bars into circular shape by respectively grinding, peeling and flattening prior to subsequent threading.

FIGS. 2a and 2b are schematic views of a 4th step of a present method by means of standard lathe machines or machining centers where the work piece is in rotary mount during respectively the peeling process and the threading process.

FIG. 3 is a perspective view of a 5th method by means of a tailor made machine where the work piece is in a stationary mount while the rotary peeling head and rotary threading head are assembled onto a carriage that moves back and forth in both plane directions X & Y.

FIG. 4 is a perspective view of a machine according to the invention, where the peeling and threading means have been cut off to show the internal parts.

FIG. 5 is a partial perspective view of the movable clamping set with the bar stopper.

FIG. 6 is a partial schematic view of the clamping chariot with opening and closing devices for the peeling and the threading head.

FIG. 7 is a partially sectional view showing the integrated peeling and hreading head aligned in the same axis and capable of peeling and threading he work piece simultaneously.

FIG. 7a and FIG. 7b show perspective views of further various shapes of thread rolling dies mounted in the threading means.

FIG. 8a through FIG. 8c are schematic views showing the steps of the process of opening and closing the peeling head.

FIG. 9a through FIG. 9c are schematic views showing the steps of a connection of deformed bars for concrete reinforcement as produced by the invention.

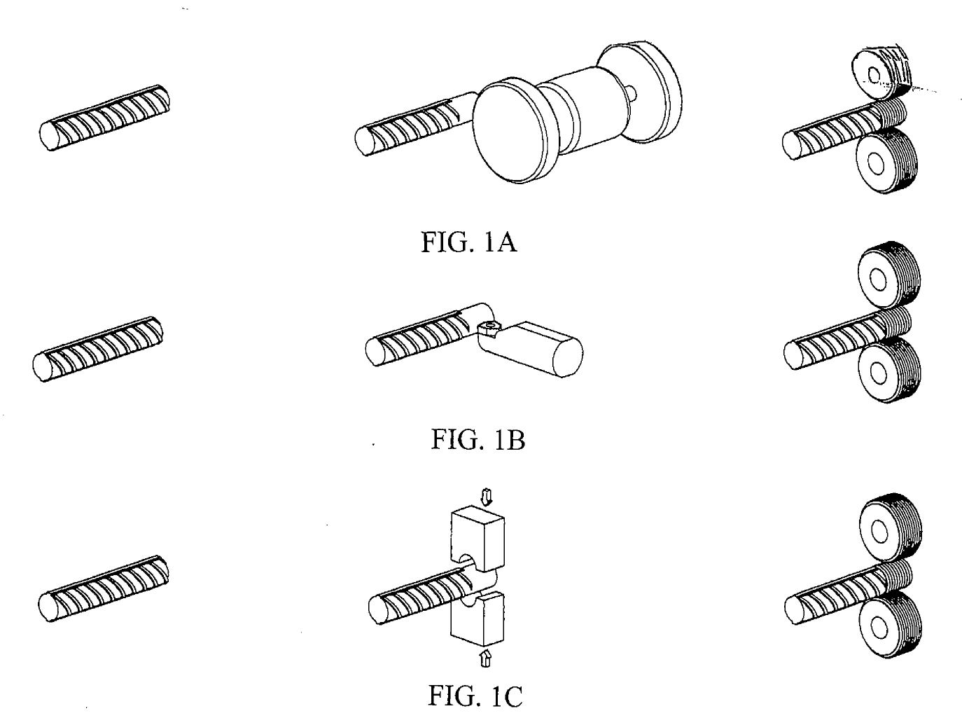

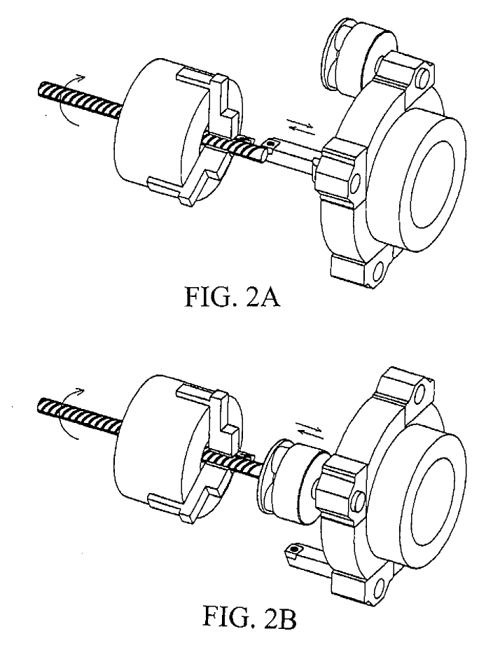

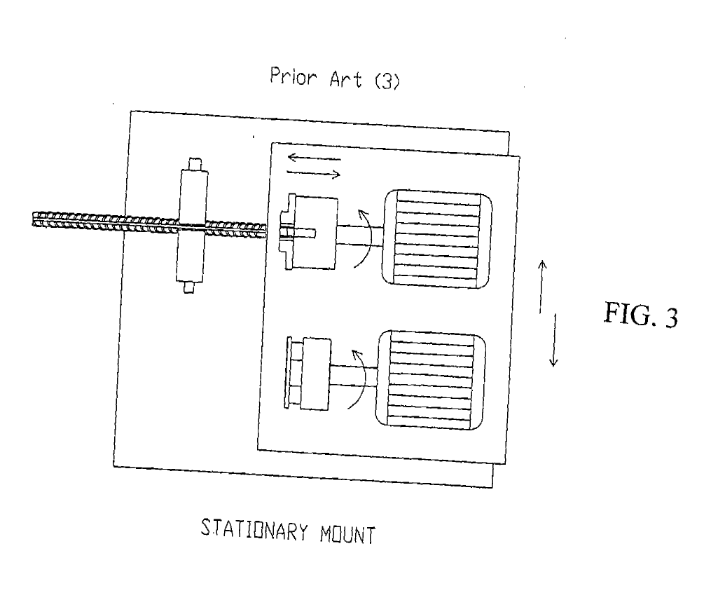

### DETAILED DESCRIPTION OF THE INVENTION

The present invention is better understood by the preferred embodiments according to the invention in reference to the drawing as follows.

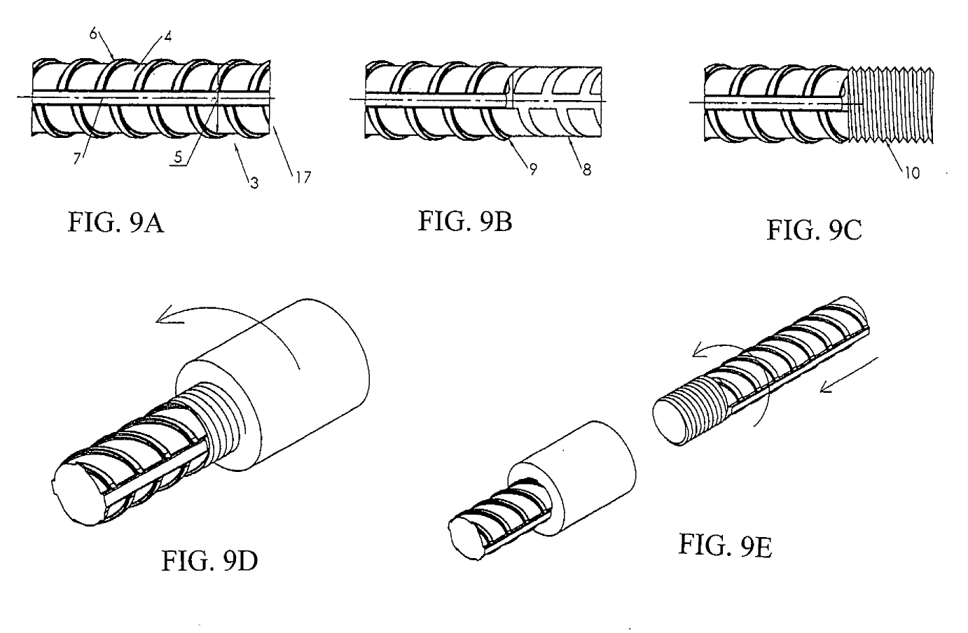

FIG. 9a shows a typical deformed bar for concrete reinforcement that the object of the invention is made to work. Such bars (3) are constituted by a core (4) that is approximately cylindrical and by ribs (6) and nodes (7) formed on an outer peripheral face thereof at variable intervals.

FIGS. 9b and 9c respectively show the result of the peeling operation and threading operation performed by the invention. The ribs (6) and the nodes (7) are generally removed by the peeling operation. However if the core (4) of the bar is not perfectly cylindrical, the ribs (6) and nodes (7) may be only partially removed, and a small part thereof may remain on said core (4) after the peeling operation the bar end (8) is cylindrical and the face (9) may be chamfered. The thread portion (10) is then formed by cutting or rolling on the outer peripheral face of the peeled portion (8) of the bar end.

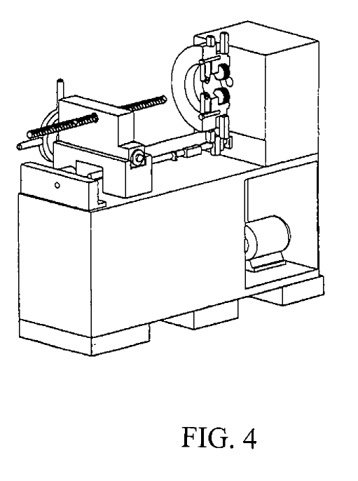

FIG. 4 shows an overall view of the basic embodiment of the invention with its peeling means (17) and threading means (18) mounted co axially on spindle (14), said spindle being powered by motor (33). The power transmission from motor (33) to spindle (14) can be either direct, or by means of a gear box, or by means of a belt and pulleys system as illustrated here, or any other power transmission method. The rotating speed of said spindle (14) can accordingly be simply adjusted by means of changing the size of pulley (32) by gear selection in a gear box, or by using a variable speed motor.

The bar (3) is mounted as a work piece in a clamping chariot (16), said clamping chariot being able to move back and forth towards said peeling and threading means. A stopper may be added to help the operator judge that there is enough length ‘l’ of a work piece protruding out of the clamping chariot.

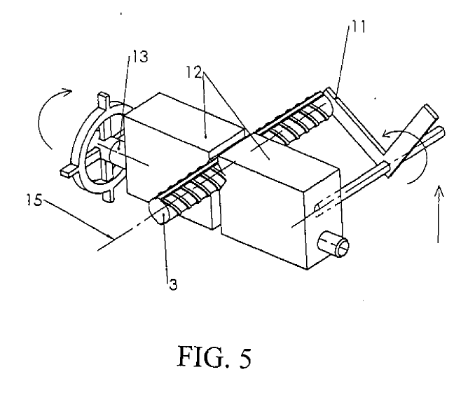

FIG. 5 shows the work piece 3 inserted between the jaw (12) of the movable clamping chariot, said chariot being then moved forward until the end (15) of work piece (3) comes into contact with the stopper (11). To hold the work piece (3) securely in position between the jaws (12), force is exerted on the clamp axle (13) by manual means, pneumatic means or hydraulic means. Therefore the stopper (11) is removed or retracted, again this movement can be done manually or be pneumatic or hydraulic assisted.

After removal or retraction of the stopper, the clamping chariot (16) holding the work piece (3) is traveled towards the rotating peeling means (17) by manual means, pneumatic means or hydraulic means and the peeling and threading processes are applied to the end of said work piece. During the peeling process, force is continuously exerted on the clamping chariot to push the work piece forward and ceased when the peeled section of the work piece is engaging into the progressive entry of threading tools (19) inside the threading means (18). The threading process continues until the desired threaded length has been achieved. The spindle rotation is then reversed to disengage the work piece from the threading tools, or, in a preferred embodiment, the threading tools can be moved outwardly to open the threading means and release the work piece. The clamping chariot (16) is then returned to its original position and the movable clamping set (12) release the work piece.

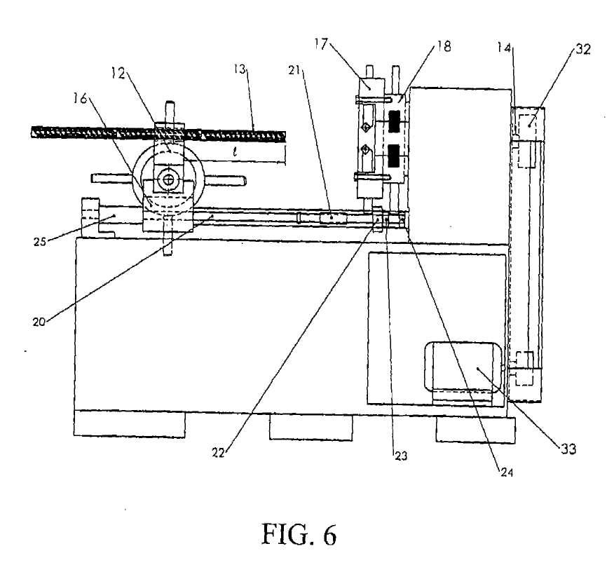

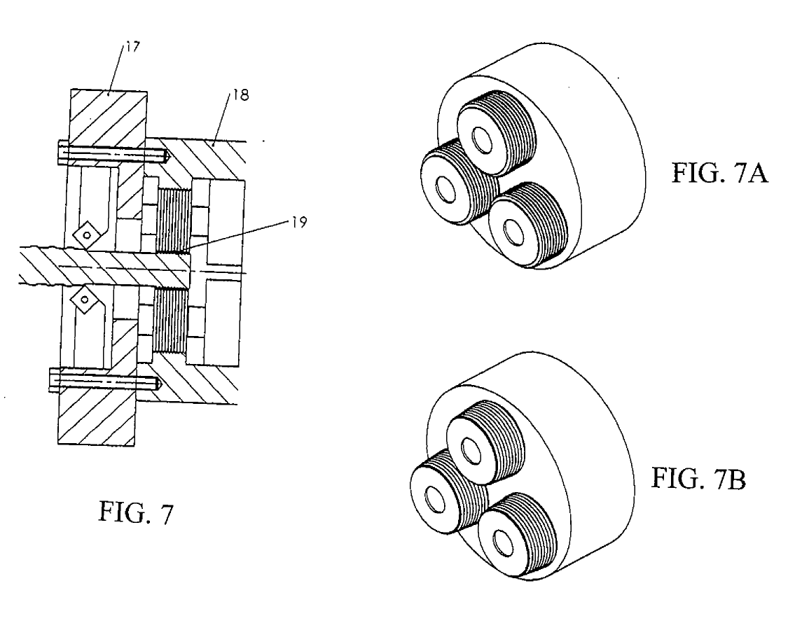

The process of peeling and threading according to the preferred embodiment of the invention is better understood by referring to FIG. 6. A leading rod (20) is attached to the clamping chariot(16), said leading rod (20) comprising peeling means opening controller (21), peeling means closing controller (22), threading means opening controller (23) and threading closing controller (24). This whole unit is able to move forward and backward supported by carriage sets (25). Both peeling means opening controller (21) and threading means opening controller (23) are adjustable by moving them along leading rod (20) to accommodate various thread lengths. Therefore while producing long threads, both the peeling means (17) and the threading means (18) can be operated simultaneously, as illustrated in FIG. 7. Both peeling means closing controller (22) and threading means closing controller (24) are fixed to the leading rod (20). Both the peeling means(17) and the threading means(18) are closed concurrently when the clamping chariot (16) is returned to its original position.

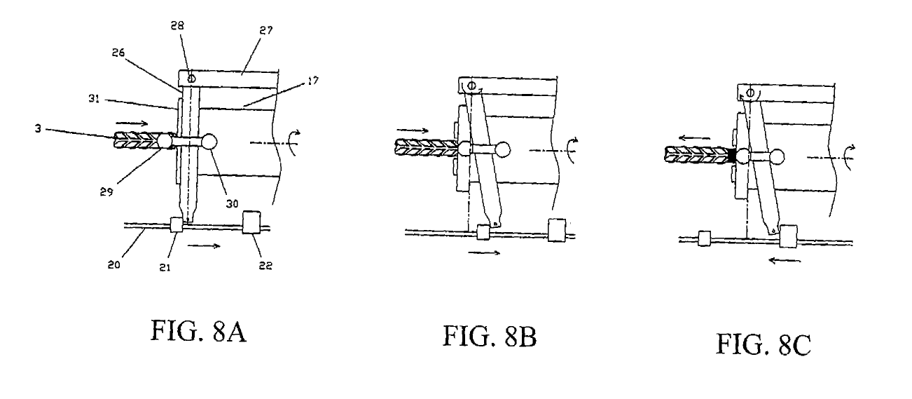

FIG. 8 shows further in detail the successive steps of peeling and threading means opening and closing, starting from an original set up with both means closed in FIG. 8a, the forward movement of leading rod (20) leads peeling means opening controller (21) to contact yoke ring (26). Yoke ring (26) swings around the axle (28) of yoke clamp support (27) leading front yoke ring stopper set (29) to act on peeling means outer ring (31), thereby opening said peeling means (17) and allowing work piece (3) to further penetrate into said peeling means and towards threading means as illustrated in FIG. 8b.

Threading means opening controller (23) works in similar fashion to stop the threading operation by opening up threading means (18) once a desired threading length has been achieved, which had been pre-set by adjusting the location of said threading means opening controller (23) on leading rod (20). In order to retrieve the finished work piece (3), the clamping chariot (16) is then moved backwards, taking along its leading rod (20), both threading means closing controller (24) and peeling means closing controller (22) push their respective yoke rings back into position as illustrated in FIG. 8c, thereby closing said peeling and threading means.

While the invention has been described with reference to preferred embodiment various changes and uses for machine operation are made that are automatic and controlled by a computerized system. A sensor detects the insertion of the work piece and starts the cycle. A pressure switch on the clamping device sends the signal to lift the stopper. The carriage moves forward, its traveling stroke controlled either by a sensor or by a timer. A proximity sensor finally detects the end of the threading operation and brings the carriage back. The first sensor then detects the end of the threading operation and brings the carriage back. The first sensor then detects that the work piece has been removed and allows the stopper to come down.

A pressure switch is fitted to the feeding system and shuts the machine down in case of over pressure. This is a safety feature made to protect the threading tools from damage, in case for some reason, such as tool wear and tear, the bar end is too big after peeling.

While the invention has been described with reference to preferred embodiment various changes may be made in the constructional features of the machine and equivalent may be substituted for elements thereof without departing from the scope of the invention. Therefore, it is intended that the invention not be limited to the particular embodiment disclosed as the best mode contemplated for carrying out this invention, but that the invention will include all embodiments falling within the scope of the appended claims.

1. A threading machine for end threading of long metal bars comprises:
peeling means;
threading means mounted co-axially on a spindle, said spindle being powered by a motor; and
a leading rod attached to a clamping chariot, said leading rod comprises peeling means opening and closing a controller, said threading means opening and closing controller, being supported by carriage set and being moveable forward and backward, said peeling means opening controller and threading means opening controller being adjustable by moving along leading rod to accommodate various thread lengths.

2. A threading machine for the end threading of long metal bars as claimed in claim 1, further comprising a rotary means fixed on a machine chassis and a clamp holding a work piece moving back and forth to the rotary means.

3. A threading machine for the end threading of long metal bars as claimed in claim 1, further comprising a clamp holding the work piece fixed on the machine chassis and a rotary means moving back and forth to the work piece.

4. A threading machine for the end threading of long metal bars as claimed in claim 1 wherein a threading head is comprised of a thread cutting head.

5. A threading machine for the end threading of long metal bars as claimed in claim 1 wherein a threading head is comprised of a thread rolling head.

6. A threading machine for the end threading of long metal bars as claimed in claim 1, wherein peeling tools and threading tools are housed in a tingle rotary head.

7. A threading machine for the end threading of long metal bars as claimed in claim 1, wherein peeling and threading of the bar is simultaneous.

8. A threading machine for the end threading of long metal bars as claimed in claim 1, wherein a rolling head accommodates a non-chamfered work piece.

9. A threading machine for the end threading of long metal bars as claimed in claim 1, wherein a peeling head automatically opens and closes by the relative forward and backward movement of the clamping chariot holding the work piece.

10. A threading machine for the end threading of long metal bars as claimed in claim 1, wherein a threading head automatically opens and closes by the relative forward and backward movement of the clamping chariot holding the work piece.

11. A threading machine for the end threading of long metal bars as claimed in claim 1, wherein a device opening the peeling head is retractable, allowing the clamping chariot bring the work piece farther into the rolling head.

12. A threading machine for the end threading of long metal bars as claimed in claim 1, wherein a device opening the peeling head has less height than a device closing the peeling head, allowing the clamping chariot bring the work piece farther into the rolling head.

13. A threading machine for the end threading of long metal bars as claimed a claim 1, wherein head opening devices are adjustable so that the length of the peeling and/or the length of the threading can be adjusted.

14. A threading machine for the end threading of long metal bars as claimed in claim 1, wherein the rolling head comprises a plurality of satellite rolling dies.

15. A threading machine for the end threading of long metal bars as claimed in claim 1, wherein the rolling dies can be removed and inserted without removal of the peeling means.

16. A threading machine for the end threading of long metal bars as claimed in claim 1, wherein the rolling dies are of oval shape with progressive entry.

17. A threading machine for the end threading of long metal bars as claimed in claim 1, wherein axles of the rolling dies open up by moving outwardly away from the spindle axis at the end of the threading operation.

18. A threading machine for the end threading of long metal bars as claimed in claim 1, wherein rotation speed of the spindle is adjustable during the cycle time.

19. A threading machine for the end threading of long metal bars as claimed in claim 1, further comprising:
a safety device shutting down the machine if the bar end after peeling is too big.

20. A threading machine for the end threading of long metal bars as claimed in claim 1, wherein guides on which the chariot is moving are fitted with shock absorbers.

21. A threading machine for the end threading of long metal bars as claimed in claim 1, wherein a sequence of operation is automatic and controlled by a computerized system.

22. A threading machine for the end threading of long metal bars as claimed in claim 1, further comprising:
a sensor provided for detecting the proper removal of the work piece at the end of the operation in order to allow proceeding to the next cycle.

23. A threading machine for end threading of metal bars substantially as herein before described according to claim 1 with reference to the accompanying drawings.
